(19) United States
(12) Patent Application Publication
(10) Pub. No.: US 2025/0220570 A1
(43) Pub. Date: Jul. 3, 2025

(54) Motion-Aware and Load-Balanced Assisted Roaming

(71) Applicant: Cisco Technology, Inc., San Jose, CA (US)

(72) Inventors: Richa Daga, NEW DELHI (IN); Vinay Saini, BANGALORE (IN); Howard Haifeng Zhang, BEIJING (CN); Srikar Chaitanya Nistala, HYDERABAD (IN); Poojalakshmi D, BANGALORE (IN); Ruchi Agrawal, BANGALORE (IN)

(21) Appl. No.: 18/921,645

(22) Filed: Oct. 21, 2024

(30) Foreign Application Priority Data
Dec. 28, 2023 (IN) 202341089384

(51) Int. Cl. H04W 48/20; H04W 28/02; H04W 48/16; H04W 72/51

(52) U.S. Cl. CPC H04W 48/20; H04W 28/0226; H04W 48/16; H04W 72/51

(57) ABSTRACT

Existing roaming protocols overlook certain factors such as direction and speed of mobile devices, client mix, and profiles during assisted roaming, leading to less relevant access point (AP) suggestions. Therefore, devices, systems, methods, and processes for motion-aware and load-balanced assisted roaming are described herein. Multiple mobile devices roaming in an area and having similar motion attributes are grouped. A roaming candidate list including potential APs is identified for the group. This list is further segmented into unique sub-lists, which are then transmitted to the mobile devices based on the motion attributes and connectivity needs. Furthermore, traffic load for each potential AP is predicted and traffic alert notifications are transmitted to the potential APs. The traffic alert notification indicates the predicted traffic load or mobile device types expected to connect to the potential AP. Thus, ensuring optimal network performance, efficient resource management, and enhanced roaming experience in dynamic environments.

The present disclosure relates to wireless networks. More particularly, the present disclosure relates to motion-aware and load-balanced assisted roaming in wireless networks.

This application claims the benefit of Indian Provisional Patent Application No. IN202341089384, filed Dec. 28, 2023, which is incorporated by reference herein in its entirety.

### BACKGROUND

Mechanisms defined by IEEE 802.11 standards for Wi-Fi roaming provide support for seamless connectivity as mobile devices move between access points (APs). For example, the IEEE 802.11r standard focuses on reducing handoff time by enabling quicker authentication processes. Further, IEEE 802.11k/v standards improve roaming efficiency by allowing the current AP to assist connected mobile devices in identifying the best next AP for roaming. In other words, these mechanisms aim to maintain consistent connectivity and optimize user experience by facilitating smooth transitions between APs as the mobile devices roam.

Despite the advancements, current Wi-Fi roaming mechanisms have various limitations. For example, the existing assisted roaming mechanisms prioritize certain metrics such as signal strength in the decision-making process; however, may overlook other metrics (for example, motion of mobile devices, types of mobile devices, etc.) that affect the quality of the wireless connection. Disregarding these additional factors may lead to sub-optimal roaming decisions, potentially degrading the user experience.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system in accordance with various embodiments of the disclosure;

FIG. 2 is a conceptual depiction of a communication layer architecture in accordance with various embodiments of the disclosure;

FIG. 3 is a conceptual network diagram of various environments in which an assisted roaming logic may operate in accordance with various embodiments of the disclosure;

FIG. 4 is a conceptual block diagram of an example wireless network in accordance with various embodiments of the disclosure;

FIG. 5 is a conceptual diagram of an example wireless network in accordance with various embodiments of the disclosure;

FIG. 6 is a flowchart showing a process for motion-aware and load-balanced assisted roaming in accordance with various embodiments of the disclosure;

FIG. 7 is a flowchart showing a process for motion-aware and load-balanced assisted roaming with assisted sensing mode in accordance with various embodiments of the disclosure;

FIG. 8 is a flowchart showing a process for motion-aware and load-balanced assisted roaming with assisted sensing mode in accordance with various embodiments of the disclosure;

FIG. 9 is a flowchart showing a process for alerting potential roaming candidate APs regarding a crowded roaming event in accordance with various embodiments of the disclosure; and

FIG. 10 is a conceptual block diagram of a device suitable for configuration with an assisted roaming logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### SUMMARY OF THE DISCLOSURE

Systems and methods for facilitating motion-aware and load-balanced assisted roaming in wireless networks in accordance with embodiments of the disclosure are described herein. In many embodiments, a device including a processor, a network interface controller configured to provide access to a network, and a memory communicatively coupled to the processor, is provided. The memory includes an assisted roaming logic that is configured to group, based on similarity in one or more motion attributes, a set of mobile devices roaming in an area, and identify a roaming candidate list for the set of mobile devices based on the one or more motion attributes. The assisted roaming logic is further configured to segment the roaming candidate list into one or more roaming candidate sub-lists and transmit a roaming candidate sub-list of the one or more roaming candidate sub-lists to at least one mobile device of the set of mobile devices.

In a number of embodiments, each of the one or more roaming candidate sub-lists has a unique selection of roaming candidate access points (APs).

In a variety of embodiments, the unique selection of roaming candidate APs is based on one or more configuration parameters of the set of mobile devices.

In more embodiments, the roaming candidate list includes a plurality of roaming candidate APs for the set of mobile devices.

In yet more embodiments, the roaming candidate list is segmented into the one or more roaming candidate sub-lists based on load balancing among the plurality of roaming candidate APs.

In still more embodiments, the assisted roaming logic is further configured to receive the one or more motion attributes of the set of mobile devices from a plurality of sensing devices in the area and determine that the similarity in the one or more motion attributes of the set of mobile devices is less than a similarity threshold. The set of mobile devices is grouped based on the determination that the similarity in the one or more motion attributes of the set of mobile devices is less than the similarity threshold.

In still yet more embodiments, the one or more motion attributes include at least one of a movement direction, a movement speed, or a movement velocity.

In further embodiments, the assisted roaming logic is further configured to assign a common identifier to the plurality of sensing devices.

In additional embodiments, the plurality of sensing devices assigned with the common identifier operates as a coordinated sensing system that intercommunicates.

In many further embodiments, the assisted roaming logic is further configured to activate an assisted sensing mode of the device.

In further additional embodiments, activating the assisted sensing mode includes operating the plurality of sensing devices along with one or more assisted sensing devices.

In many additional embodiments, the one or more assisted sensing devices includes at least one Internet of Things (IoT) sensor.

In numerous embodiments, the assisted roaming logic is further configured to compare a sensing resolution of the plurality of sensing devices with a sensing resolution threshold and activate the assisted sensing mode in response to the sensing resolution of the plurality of sensing devices being less than the sensing resolution threshold.

In several embodiments, the assisted roaming logic is further configured to determine a count of mobile devices in the area served by the plurality of sensing devices, compare the determined count of mobile devices with a threshold count, and activate the assisted sensing mode based on the count of mobile devices in the area being greater than the threshold count.

In numerous additional embodiments, the plurality of sensing devices includes one or more sensing-enabled APs, one or more sensing-enabled wireless network controllers, or one or more sensing-enabled dynamic network access controllers.

In several additional embodiments, the device is one of a wireless network controller, a dynamic network access controller, or an AP.

In several more embodiments, a device including a processor, a network interface controller communicatively coupled to a plurality of network devices deployed in an area, and a memory communicatively coupled to the processor, is provided. The memory includes an assisted roaming logic that is configured to group, based on similarity in one or more motion attributes, a set of mobile devices roaming in the area and identify a roaming candidate list for the set of mobile devices. The roaming candidate list includes one or more network devices of the plurality of network devices. The assisted roaming logic is further configured to edict a traffic load for each of the one or more network devices and transmit a traffic alert notification to each of the one or more network devices based on the predicted traffic load.

In still yet further embodiments, the roaming candidate list is identified based on the one or more motion attributes of the set of mobile devices.

In still additional embodiments, the traffic alert notification transmitted to a network device of the one or more network devices is configured to indicate at least one of the traffic load or a type of mobile device expected to connect to the network device.

In still yet additional embodiments, an assisted roaming method includes grouping, based on similarity in one or more motion attributes, a set of mobile devices roaming in an area, and identifying a roaming candidate list for the set of mobile devices based on the one or more motion attributes. The method further includes segmenting the roaming candidate list into one or more roaming candidate sub-lists and transmitting a roaming candidate sub-list of the one or more roaming candidate sub-lists to at least one mobile device of the set of mobile devices.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### DETAILED DESCRIPTION

In response to the issues described above, devices and methods are discussed herein that facilitate motion-aware and load-balanced assisted roaming in a wireless network. Existing Wi-Fi standards such as 802.11r facilitate rapid roaming between access points (APs) in a network, enabling clients (e.g., mobile devices) to switch APs with minimal delay. Moreover, standards such as 802.11k and 802.11v provide assisted roaming capabilities, where APs provide clients with a list of potential APs to connect to as they roam. These technologies strive to maintain uninterrupted connectivity and enhance the user experience by enabling smooth transitions between APs. Despite the advancements, the current Wi-Fi roaming mechanisms have various limitations. In many scenarios, the existing assisted roaming mechanisms prioritize certain metrics such as signal strength in the decision-making process; however, may overlook other metrics (for example, device motion, device type, traffic load distribution among the APs, etc.) that affect the quality of the wireless connection. For example, a mobile device might be directed to an AP with a strong signal but high congestion, resulting in sub-optimal performance. In another example, if device motion is not accounted for while generating a list of potential APs for a mobile device, the list of potential APs may include APs with strong signals at the current moment, regardless of their likelihood to be in a travel path of the mobile device. In other words, disregarding these additional factors can lead to sub-optimal roaming decisions, potentially degrading the user experience.

The present disclosure provides network devices (e.g., wireless network controllers “WNC”, dynamic network access controller “DNAC”, or APs) with motion-aware and load-balanced assisted roaming capabilities. For example, the network devices may include an assisted roaming logic configured to implement motion-aware and load-balanced assisted roaming. In many embodiments, a WNC may be configured to manage and optimize a plurality of APs (hereinafter, collectively referred to as “the APs”) deployed in an area. The APs may be configured to provide wireless connectivity to a plurality of mobile devices (hereinafter, collectively referred to as “the mobile devices”) operated by one or more users roaming in the area. Examples of the mobile devices may include, but are not limited to, smartphones, laptops, tablets, phablets, E-readers, portable gaming consoles, digital cameras, portable media players, portable smart home devices, Augmented Reality (AR) devices, Internet-of-Things (IoT) devices, wearables, or the like.

In numerous embodiments, one or more network devices deployed in the area can be sensing-enabled. For example, one or more APs among the plurality of APs may be sensing-enabled. In further examples, the WNC or the DNAC can also be enabled for Wi-Fi sensing. Such sensing-enabled network devices (also referred to as “sensing devices”) may be strategically located in the area to maximize the coverage and accuracy of data collection. The sensing devices may be configured to sense and track one or more motion attributes of the mobile devices roaming in the area. For example, the sensing devices deployed in the area can detect the motion attributes of a user's smartphone as the user moves from one point in the area to another. These sensing devices can track the motion attributes in real time based on the presence and movement of the users within the area. The motion attributes sensed by the sensing devices may include, but are not limited to, movement direction, movement speed and velocity, or movement activities (e.g., walking, running, stationary, etc.).

In a number of embodiments, the sensing devices operating in the area may be grouped and assigned a unique common identifier by the WNC. For example, transceivers of the sensing devices may be assigned the common identifier by the WNC. The sensing devices assigned with the common identifier may be configured to operate as a coordinated sensing system that intercommunicates. In other words, the sensing devices, operating as the coordinated sensing system (e.g., a virtual group), may be configured to share sensed information regarding the motion attributes of the mobile devices with each other.

In more embodiments, the WNC may be configured to receive the motion attributes sensed by the sensing devices. In other words, the WNC may receive information regarding the movement direction, the movement speed, the movement velocity, and/or the movement activity of the mobile devices roaming in the area. The WNC may be configured to determine a similarity in the motion attributes of the mobile devices. The similarity in the motion attributes can be determined based on a similarity threshold. In yet various embodiments, the WNC may be configured to group a set of mobile devices, among the plurality of mobile devices, based on the similarity in the motion attributes. For example, if the similarity in the motion attributes of two mobile devices is less than the similarity threshold, the WNC may group the two mobile devices. However, if the similarity in the motion attributes of two mobile devices is greater than the similarity threshold, the two mobile devices may be considered to have dissimilar movement patterns and hence may not be considered as part of the same group. Such grouping based on similarity in motion attributes may help in optimizing resource allocation and improving overall customer experience.

In further embodiments, the WNC may be configured to identify a roaming candidate list for the set of mobile devices grouped. For example, the roaming candidate list may refer to a list of a plurality of roaming candidate APs that the set of mobile devices can connect to as they continue moving toward their destination. In still additional embodiments, the WNC may segment the roaming candidate list into one or more roaming candidate sub-lists. In still further embodiments, the roaming candidate list may be segmented into the one or more roaming candidate sub-lists based on load balancing among the plurality of roaming candidate APs. For example, the WNC may predict a traffic load for each of the plurality of roaming candidate APs and balance the predicted traffic load among the plurality of roaming candidate APs. The WNC may perform the load balancing among the plurality of roaming candidate APs based on a client mix and data usage of the set of mobile devices. Each of the one or more roaming candidate sub-lists may have a unique selection of roaming candidate APs based on client profile and mix. For example, the WNC may identify a roaming candidate list with three potential roaming candidate APs for a group of 20 mobile devices. To balance the load and client mix among the three potential roaming candidate APs, the WNC may segment the roaming candidate list into three sub-lists, with each sub-list having the currently connected AP and two potential roaming candidate APs from the roaming candidate list.

In some more embodiments, the WNC may transmit a roaming candidate sub-list of the one or more roaming candidate sub-lists to at least one mobile device of the set of mobile devices. In other words, the WNC may transmit a specific sub-list to a mobile device, guiding the mobile device to connect to the most optimal AP from the sub-list. Since different mobile devices in the same group may receive different sub-lists, the likelihood of all the mobile devices in the same group requesting connection to the same potential roaming candidate AP at the same time is reduced, resulting in improved network performance and reduced network congestion.

In yet more embodiments, the WNC may be configured to predict traffic load for each of the roaming candidate APs. For example, the WNC may predict traffic load for a roaming candidate AP based on transmitted sub-lists that include the roaming candidate AP as a potential roaming option. For example, if two sub-lists include the roaming candidate AP as a potential roaming option and each sub-list is sent to two mobile devices, the traffic load for the roaming candidate AP can be predicted based on historical traffic analysis of the four mobile devices. The WNC may be further configured to transmit a traffic alert notification to each of the roaming candidate APs based on the predicted traffic load. The traffic alert notification to a roaming candidate AP may include information indicating at least one of the predicted traffic load or a type of mobile device expected to connect to the roaming candidate AP. This information may allow each roaming candidate AP to get prepared for an upcoming roaming event and impending traffic. The roaming candidate APs can skip off-channel scan cycles to effectively cater to the upcoming roaming event. In other words, the roaming candidate APs, based on the traffic alert notifications, may temporarily suspend background scanning activities to maintain strong and uninterrupted connections for roaming mobile devices. This approach may enhance network performance by evenly distributing the load and managing client diversity, ensuring a seamless experience for roaming mobile devices without overloading any single AP.

In still yet more embodiments, the WNC may be configured with an assisted sensing mode. The WNC may activate the assisted sensing mode if the sensing devices are unable to provide accurate information about the motion attributes of the mobile devices in the area. For example, the WNC may compare a sensing resolution of the sensing devices with a sensing resolution threshold. If the sensing resolution of the sensing devices is less than the sensing resolution threshold, the WNC may activate the assisted sensing mode. In further examples, the WNC may determine a count of mobile devices in the area served by the sensing devices and compare the determined count of mobile devices with a threshold count. If the determined count of mobile devices is greater than the threshold count, the WNC may activate the assisted sensing mode. In several embodiments, the assisted sensing mode can be further enabled at all times based on configuration parameters of the sensing devices. In the assisted sensing mode, the WNC may operate the sensing devices along with one or more assisted sensing devices to obtain the motion attributes of the mobile devices in the area. The one or more assisted sensing devices may include at least one Internet of Things (IoT) (e.g., image sensors, video sensors, audio sensors, AR sensors, Infrared sensors, motion detectors, or the like) strategically placed in the area to maximize coverage and accuracy of data collection. In other words, in the assisted sensing mode, the assisted sensing devices in the area may be engaged to work in collaboration with the sensing devices to sense the motion attributes of the mobile devices. Such collaborative sensing may ensure that the network maintains high-quality user detection and monitoring, even when the sensing devices alone are not sufficient.

Although in the above description a WNC is described to be facilitating the motion-aware and load-balanced assisted roaming, in further additional embodiments, the above-described operations can also be performed by an AP, a standalone device with assisted roaming logic, or the like. Thus, the above-described motion-aware and load-balanced assisted roaming approach offers significant advantages by ensuring seamless connectivity and optimized performance. By enabling motion-aware and load-balanced assisted roaming, traffic load is distributed evenly among potential roaming candidate APs, preventing the roaming candidate APs from becoming overloaded. Further, such assisted roaming may lead to reliable and resilient network performance, particularly in environments with diverse client mixes and high mobility.

Aspects of the present disclosure may be embodied as an apparatus, system, method, or computer program product. Accordingly, aspects of the present disclosure may take the form of an entire hardware embodiment, an entire software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

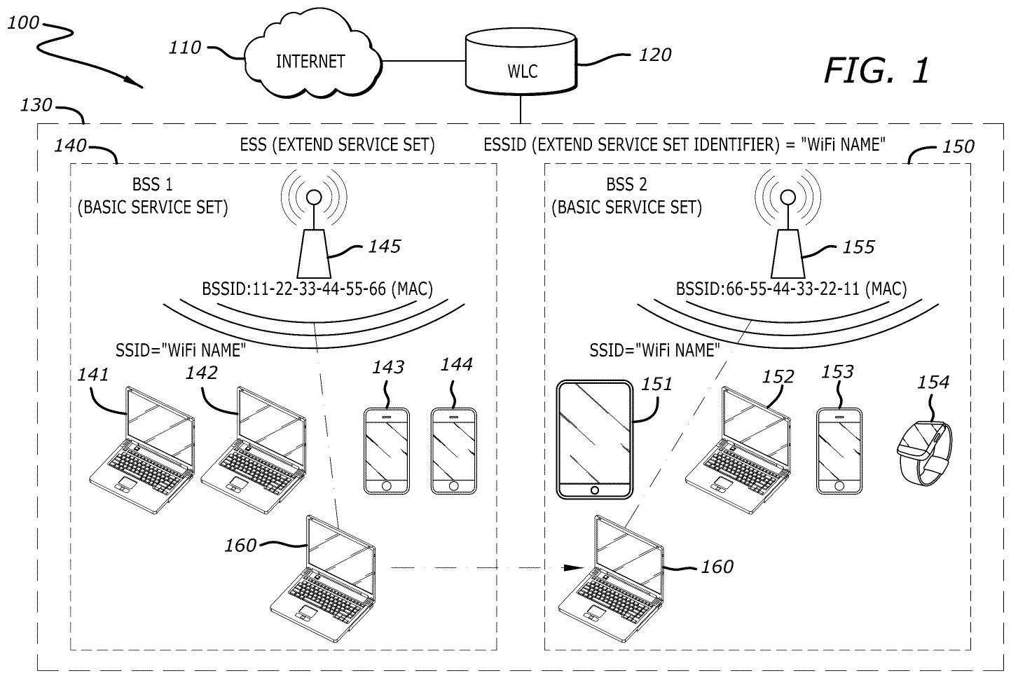

Referring to FIG. 1, a schematic block diagram of a wireless local networking system 100 in accordance with various embodiments of the disclosure is shown. Wireless local networking standards play an important role in enabling seamless communication and connectivity between various devices within localized areas. One of the most prevalent standards is Wi-Fi, which is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends a service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

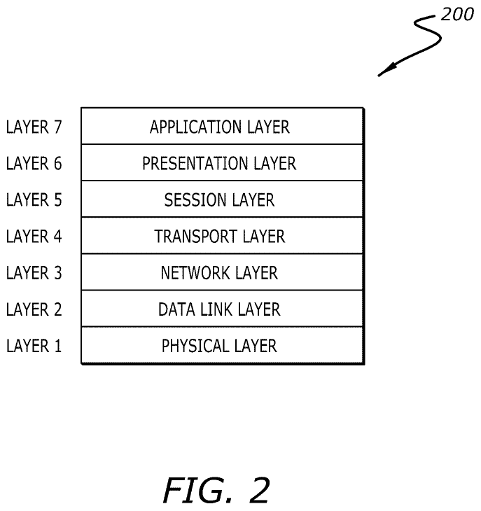

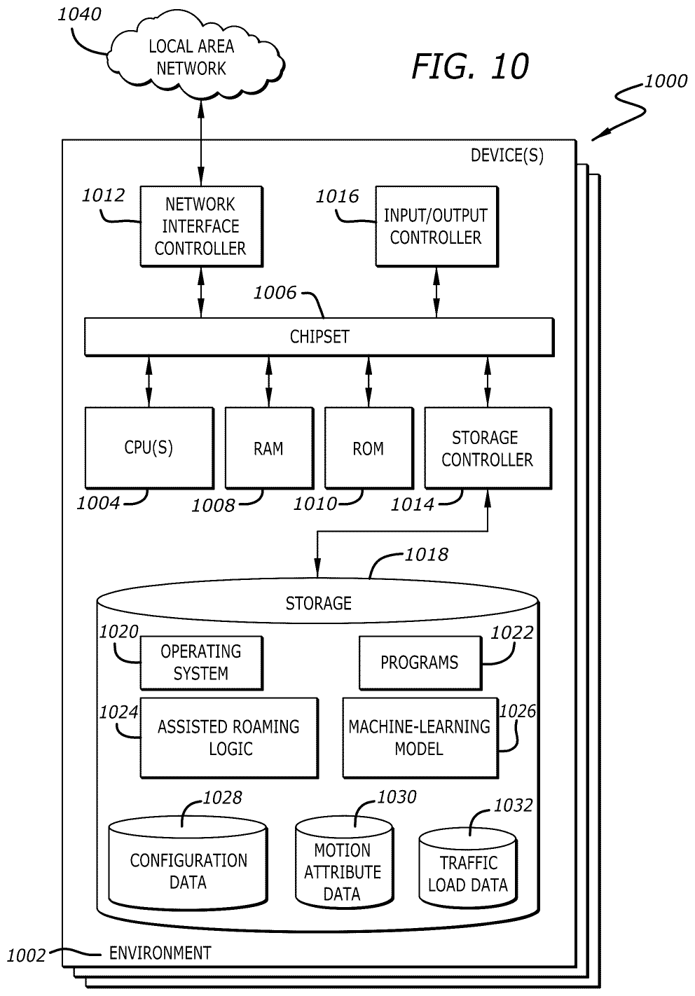

The network can include a variety of user end devices that connect to the network. These devices can sometimes be referred to as stations (“STAs”). These devices may also be referred to as mobile devices. Each device is typically configured with a medium access control (“MAC”) address in accordance with the IEEE 802.11 standard. As described in more detail in FIG. 2, a physical layer can also be configured to communicate over the wireless medium. As described in more detail in FIG. 10, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “Wi-Fi Name”, which can be a BSSID for each of the BSS 1 140 and BSS 2 150 as well as an ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). Each of these devices can communicate with the second access point 155. The third notebook 160 is communicatively coupled to both the first BSS 1 140 and the second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-10 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance with the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and MAC. The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the Internet and other large-scale networks.

In additional embodiments, the fourth transport layer can be a critical element responsible for the end-to-end communication and reliable delivery of data between devices. Its primary objectives include error detection and correction, flow control, segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with the embodiments of the disclosure. For example, various aspects described herein may reside or be carried out on one layer, or a plurality of layers. The elements depicted in FIG. 2 may also be interchangeable with other elements of FIG. 1 and FIGS. 3-10 as required to realize a particularly desired embodiment.

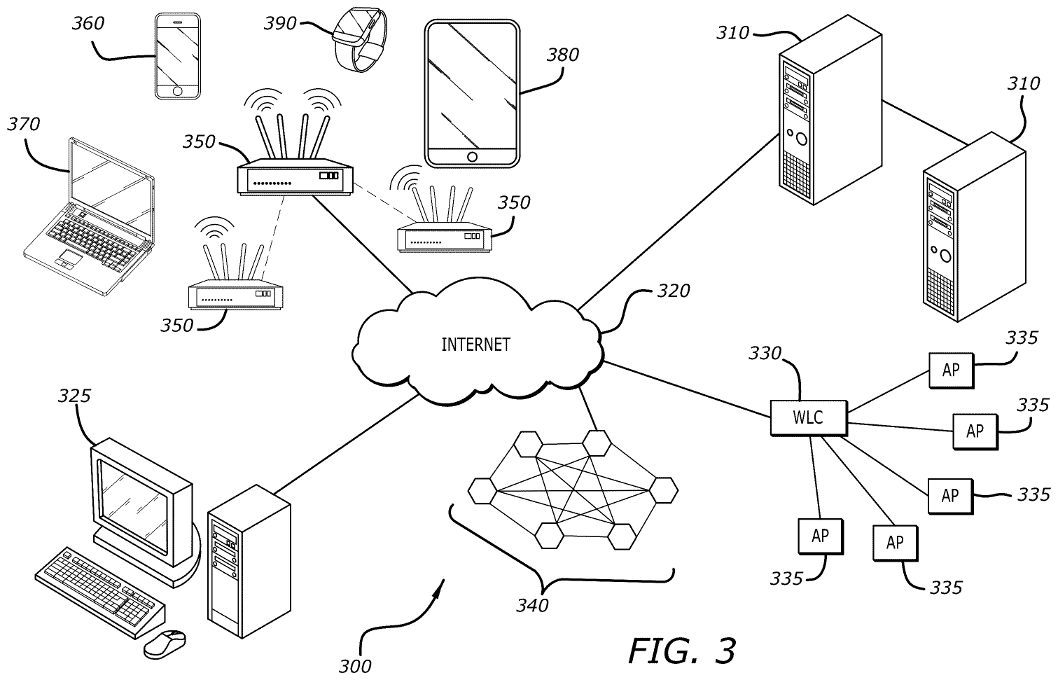

Referring to FIG. 3, a conceptual network diagram 300 of various environments in which an assisted roaming logic may operate in accordance with various embodiments of the disclosure is shown. Those skilled in the art will recognize that the assisted roaming logic can include various hardware and/or software deployments and can be configured in a variety of ways. In many embodiments, the assisted roaming logic can be configured as a standalone device, exist as a logic in another network device, be distributed among various network devices operating in tandem, or be remotely operated as part of a cloud-based network management tool. In further embodiments, one or more servers 310 can be configured with the assisted roaming logic or can otherwise operate as the assisted roaming logic. In many embodiments, the assisted roaming logic may operate on one or more servers 310 connected to a communication network 320 (shown as the “Internet”). The communication network 320 can include wired networks or wireless networks. The assisted roaming logic can be provided as a cloud-based service that can service remote networks, such as, but not limited to a deployed network 340.

However, in additional embodiments, the assisted roaming logic may be operated as a distributed logic across multiple network devices. In the embodiment depicted in FIG. 3, a plurality of network access points (APs) 350 can operate as the assisted roaming logic in a distributed manner or may have one specific device operate as the assisted roaming logic for all of the neighboring or sibling APs 350. The APs 350 may facilitate Wi-Fi connections for various electronic devices, such as but not limited to, mobile computing devices including laptop computers 370, cellular phones 360, portable tablet computers 380, and wearable computing devices 390.

In further embodiments, the assisted roaming logic may be integrated within another network device. In the embodiment depicted in FIG. 3, a wireless LAN controller (WLC) 330 may have an integrated assisted roaming logic that the WLC 330 can use to monitor or control power consumption of the APs 335 that the WLC 330 is connected to, either wired or wirelessly. In still more embodiments, a personal computer 325 may be utilized to access and/or manage various aspects of the assisted roaming logic, either remotely or within the network itself. In the embodiment depicted in FIG. 3, the personal computer 325 communicates over the communication network 320 and can access the assisted roaming logic of the servers 310, or the network APs 350, or the WLC 330.

Although a specific embodiment for various environments that the assisted roaming logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the assisted roaming logic may be provided as a device or software separate from the WLC 330, or the assisted roaming logic may be integrated into the WLC 330. The elements depicted in FIG. 3 may also be interchangeable with other elements of FIGS. 1-2 and FIGS. 4-10 as required to realize a particularly desired embodiment.

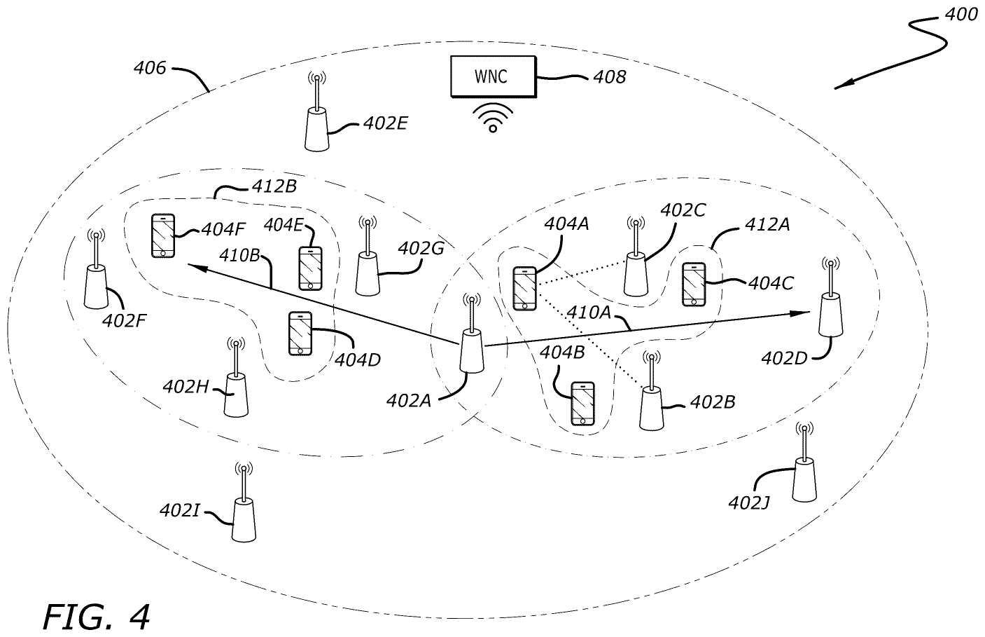

Referring to FIG. 4, a conceptual diagram of an example wireless network 400 in accordance with various embodiments of the disclosure is shown. The embodiments shown in FIG. 4 may illustrate a scenario where a plurality of APs 402A, 402B, . . . , 402J are deployed to provide connectivity to multiple mobile devices 404A, 404B, . . . , 404F roaming in an area 406. In the embodiment depicted in FIG. 4, the plurality of APs 402A-402J may be communicatively coupled to a wireless network controller “WNC” 408 (for example, a WLC, a Dynamic Network Access Controller “DNAC”, or the like). The wireless network 400 can be set up in various environments. For example, the wireless network 400 can be confined within a building, with the plurality of APs 402A-402J located indoors. In another example, the wireless network 400 can also extend to outdoor areas with some APs placed outside the building. In yet other examples, the wireless network 400 can be established in open spaces, covering outdoor areas entirely. In such examples, the plurality of APs 402A-402J may be located outdoors.

The plurality of APs 402A-402J may be network devices (e.g., network nodes), each including a processor and a network interface controller configured to provide access to a network (for example, a wireless network). Each of the plurality of APs 402A-402J may further include a memory that may be coupled with the processor and may store an assisted roaming logic that may be executable by the processor. The plurality of APs 402A-402J may execute the assisted roaming logic to perform one or more operations for motion-aware and load-balanced assisted roaming. The plurality of APs 402A-402J may be configured to provide wireless connectivity to the mobile devices 404A-404F in the area 406.

The mobile devices 404A-404F may correspond to electronic devices that roam within the area 406, connecting to the plurality of APs 402A-402J to access network services. The mobile devices 404A-404F may be equipped with wireless networking capabilities that allow the mobile devices 404A-404F to detect and connect to the plurality of APs 402A-402J. In various embodiments, the mobile devices 404A-404F may be possessed by corresponding users. As the users roam within the area 406, the mobile devices 404A-404F search for reliable signals, switching between the plurality of APs 402A-402J to maintain connection to the network (for example, the Internet). Examples of the mobile devices 404A-404F may include, but are not limited to, smartphones, laptops, tablets, phablets, E-readers, portable gaming consoles, digital cameras, portable media players, portable smart home devices, Augmented Reality (AR) devices, Internet-of-Things (IoT) devices, wearables, or the like. As shown in FIG. 4, initially the mobile devices 404A-404F may be communicatively coupled to the AP 402A.

The WNC 408 may correspond to a centralized network device configured to oversee and coordinate the plurality of APs 402A-402J deployed within the area 406. The WNC 408 may be configured to manage, configure, and monitor the plurality of APs 402A-402J. The WNC 408 may further control various tasks such as firmware updates, security protocols, and network policies across the plurality of APs 402A-402J. In yet various embodiments, the WNC 408 may include a processor and a network interface controller configured to provide access to a network (for example, a wireless network). The network interface controller may be communicatively coupled to the plurality of APs 402A-402J. The WNC 408 may further include a memory that may be coupled with the processor and may store an assisted roaming logic. The assisted roaming logic may be executable by the processor. The WNC 408 may execute the assisted roaming logic to perform one or more operations for motion-aware and load-balanced assisted roaming.

In many embodiments, one or more APs among the plurality of APs 402A-402J may be enabled with sensing capabilities (hereinafter, interchangeably referred to as sensing-enabled APs or sensing devices). For the sake of brevity, it is assumed that the plurality of APs 402A-402J are sensing-enabled APs. The plurality of APs 402A-402J may be strategically located in the area 406 to maximize sensing coverage and accuracy of data collection. These plurality of APs 402A-402J may sense and track one or more motion attributes of the mobile devices 404A-404F in the area 406. In many aspects, the plurality of APs 402A-402J can track the one or more motion attributes in real time based on the presence and movement of the mobile devices 404A-404F within the area 406. The one or more motion attributes may include movement direction (e.g., north, south, north-west, etc.), movement speed (e.g., measured in meters per second, kilometers per hour, miles per hour, etc.), movement velocity (e.g., speed with a specified direction), acceleration (e.g., rate of change of speed), position (e.g., specific location via GPS coordinates), orientation (physical tilt or angle of a mobile device), movement activities (e.g., walking, running, stationary, etc.), or the like.

In a variety of embodiments, the WNC 408 may be configured to group the sensing devices (e.g., the plurality of APs 402A-402J) operating in the area 406 and assign a common identifier. For example, the WNC 408 may assign a common identifier to transceivers of the plurality of APs 402A-402J. The sensing devices (e.g., the plurality of APs 402A-402J) that are assigned a common identifier may operate as a coordinated sensing system that intercommunicates and collaborates. In other words, based on the assignment of the common identifier, the plurality of APs 402A-402J intercommunicate to share sensed information regarding the one or more motion attributes with each other. Based on the collaboration and information sharing, the plurality of APs 402A-402J may validate the sensed information, prior to transmitting it to the WNC 408. Thus, enhancing the accuracy of the sensed information. Based on validation, the plurality of APs 402A-402J may transmit the sensed one or more motion attributes of the mobile devices 404A-404F to the WNC 408.

In a number of embodiments, the WNC 408 may be configured to receive the one or more motion attributes of the mobile devices 404A-404F from the plurality of APs 402A-402J. In other words, the WNC 408 may receive information regarding the movement direction, the movement speed, the movement velocity, and/or the movement activities of the mobile devices 404A-404F roaming in the area 406. In response to receiving the one or more motion attributes of the mobile devices 404A-404F, the WNC 408 may be configured to determine a similarity in the one or more motion attributes of the mobile devices 404A-404F. The similarity in the one or more motion attributes can be determined based on a similarity threshold.

In an example scenario, determining the similarity in the one or more motion attributes of the mobile devices 404A-404F may include normalizing the one or more motion attributes of the mobile devices 404A-404F and obtaining a motion vector for each of the mobile devices 404A-404F. A motion vector can be a multi-dimensional representation of the normalized motion attributes of a mobile device. The similarity in the motion vectors can be determined using a distance metric (such as Euclidean distance, Cosine Distance, or the like). The similarity threshold may define the maximum allowable distance metric for two mobile devices to be considered as having similar motion attributes. In other words, mobile devices for which the distance metric is less than or equal to the similarity threshold are considered to have similar motion attributes, indicating they are moving in close proximity and a similar direction. For example, if the similarity threshold is set to 5 units, and the determined distance metric between the motion attributes (or vectors) of two mobile devices is 3.6 units, the mobile devices would be considered to have similar motion attributes. However, if the determined distance metric between the motion attributes (or vectors) of two mobile devices is 6 units, the mobile devices would be considered to have dissimilar motion attributes.

In more embodiments, the WNC 408 may be configured to group a set of mobile devices, among the mobile devices 404A-404F, based on the similarity in the one or more motion attributes. For example, if the similarity in the one or more motion attributes of two or more mobile devices is less than the similarity threshold, the WNC 408 may group the two or more mobile devices. However, if the similarity in the one or more motion attributes of two or more mobile devices is greater than the similarity threshold, the two or more mobile devices may be considered to have dissimilar movement patterns, and hence may not be considered as part of the same group. As shown in FIG. 4, the WNC 408 may group a first set of mobile devices 412A (including the mobile devices 404A, 404B, and 404C) in a first group and a second set of mobile devices 412B (including the mobile devices 404D, 404E, and 404F) in a second group. The first set of mobile devices 412A may be determined to have similar motion attributes. For example, the first set of mobile devices 412A may be determined to move along a first direction (indicated by arrow 410A) at a similar speed. Likewise, the second set of mobile devices 412B may be determined to have similar motion attributes, for example, the second set of mobile devices 412B may be determined to move along a second direction (indicated by arrow 410B) at a similar speed. Such grouping based on similarity in motion attributes may help in optimizing resource allocation and improving the overall roaming experience.

As the mobile devices 404A-404F continue to move, uplink and downlink signal strengths of the mobile devices 404A-404F to the AP 402A may weaken. Such a decrease in the uplink and downlink signal strength may indicate a requirement for the mobile devices 404A-404F to transition to a new AP. In such a scenario, the WNC 408 may be configured to execute one or more operations to enable motion-aware and load-balanced assisted roaming for the mobile devices 404A-404F. For the sake of brevity, the operations performed by the WNC 408 for enabling motion-aware and load-balanced assisted roaming are described with respect to the first set of mobile devices 412A.

In additional embodiments, the WNC 408 may be configured to identify a roaming candidate list for the first set of mobile devices 412A based on the one or more motion attributes of the first set of mobile devices 412A. In an example, the roaming candidate list may refer to a list of a plurality of roaming candidate APs that the first set of mobile devices 412A can connect to as they continue moving along the first direction (indicated by arrow 410A) towards their destination. In an example scenario, the AP 402A currently coupled to the first set of mobile devices 412A may be configured to collect and maintain information about nearby APs (for example, the APs 402B-402J), including their signal strengths and communication channels. The AP 402A may transmit this information to the WNC 408. In another example scenario, the WNC 408 may collect and maintain information about the plurality of APs 402A-402J, including their signal strengths and communication channels. Further, the WNC 408 may be configured to maintain a topology database indicating a placement location of each of the plurality of APs 402A-402J in the area 406. Thus, based on the one or more motion attributes of the first set of mobile devices 412A and the topology database, the WNC 408 may identify those APs which are located along a roaming path of the first set of mobile devices 412A and can provide the required signal strength for wireless communication.

As shown in FIG. 4, the WNC 408 may identify that the APs 402B, 402C, and 402D are located along the roaming path of the first set of mobile devices 412A (e.g., along the first direction). In such a scenario, the identified APs 402B, 402C, and 402D may constitute the roaming candidate list for the first set of mobile devices 412A. Hereinafter, the APs 402B, 402C, and 402D may be referred to as “plurality of roaming candidate APs 402B, 402C, and 402D”. In an example, the roaming candidate list may correspond to a truncated version of traditional 802.11k.v list, in which potential roaming candidate APs are filtered based on the one or more motion attributes of the first set of mobile devices 412A.

In further embodiments, the WNC 408 may be configured to segment the roaming candidate list for the first set of mobile devices 412A into one or more roaming candidate sub-lists. In many aspects, the roaming candidate list may be segmented into the one or more roaming candidate sub-lists based on load balancing among the plurality of roaming candidate APs 402B, 402C, and 402D. For example, the WNC 408 may predict a traffic load for each of the plurality of roaming candidate APs 402B, 402C, and 402D and balance the predicted traffic load among the plurality of roaming candidate APs 402B, 402C, and 402D. The WNC 408 may perform the load balancing among the plurality of roaming candidate APs 402B, 402C, and 402D based on a client mix and data usage of the first set of mobile devices 412A.

In an example scenario, the WNC 408 may be configured to determine a client profile associated with each mobile device in the first set of mobile devices 412A and utilize the client profile to obtain information on the client mix in the first set of mobile devices 412A. In many aspects, the WNC 408 may analyze SSIDs, beacon frames, and/or probe packets broadcasted by the first set of mobile devices 412A to obtain information on the type of devices (IoT devices, smartphones, wearables, laptops, etc.) in the first set of mobile devices 412A, supported capabilities, data rates, or the like. In further aspects, the WNC 408 may analyze traffic patterns, encryption, communication protocols, etc. to infer the device types, traffic characteristics, or the like, while ensuring sensitive data is not exposed and user privacy is maintained. Based on the analyzed information, the WNC 408 may determine the client mix in the first set of mobile devices 412A and can predict data usage (e.g., client traffic load) associated with each of the first set of mobile devices 412A. The WNC 408 may then utilize the client mix and the predicted client traffic load to segment the roaming candidate list into the one or more roaming candidate sub-lists.

In still more embodiments, each of the one or more roaming candidate sub-lists may have a unique selection of roaming candidate APs based on the client profile and mix. In an example, to balance the load and client mix among the first set of mobile devices 412A, the WNC 408 may segment the roaming candidate list into three sub-lists, with each sub-list having the currently connected AP 402A and two potential roaming candidate APs from the roaming candidate list. Thus, a first sub-list may include the APs 402A, 402B, and 402C, a second sub-list may include the APs 402A, 402C, and 402D, and a third sub-list may include the APs 402A, 402B, and 402D.

In further additional embodiments, the WNC 408 may be configured to map and distribute the one or more roaming candidate sub-lists among the first set of mobile devices 412A. The WNC 408 may distribute each sub-list in a manner that ensures mobile devices with low and high data usage are mixed to balance the AP load. For example, the APs 402B and 402C may currently be serving mobile devices with high data usage, whereas the AP 402D may be serving medium to low data usage mobile devices. Thus, the WNC 408 may map the first sub-list to the mobile device 404A which is predicted to have low data usage, whereas the WNC 408 may map the second and third sub-lists to the mobile devices 404B and 404C, respectively.

Though in the above description, the WNC 408 segments the roaming candidate list into three sub-lists, the scope of the disclosure is not limited to it. In several embodiments, the WNC 408 can segment the roaming candidate list into any number of sub-lists and one sub-list can be mapped to more than one mobile devices. Further, the one or more sub-lists can have an unequal number of APs based on load balancing.

In several more embodiments, the WNC 408 may be configured to segment the roaming candidate list identified for the first set of mobile devices 412A based on a count of mobile devices in the first set of mobile devices 412A. For example, if the count of mobile devices in the first set of mobile devices 412A is less than a set threshold value, the WNC 408 may not segment the roaming candidate list, whereas if the count of mobile devices in the first set of mobile devices 412A is greater than or equal to the set threshold value, the WNC 408 may segment the roaming candidate list. Further, a count of roaming candidate sub-lists may be based on a count of roaming candidate APs in the roaming candidate list and the count of mobile devices. For example, the WNC 408 may identify a roaming candidate list with four potential roaming candidate APs for a group of 20 mobile devices. To balance the load and client mix among the four potential roaming candidate APs, the WNC 408 may segment the roaming candidate list into five sub-lists, with each sub-list having the currently connected AP and two or more potential roaming candidate APs from the roaming candidate list as per the client mix and load balancing.

In other words, the WNC 408 may transmit a specific sub-list to a mobile device, guiding the mobile device to connect to the most optimal AP from the sub-list. Since different mobile devices in the same group may receive different sub-lists, the likelihood of all the mobile devices in the same group requesting connection to the same potential roaming candidate AP at the same time is reduced, resulting in improved network performance and reduced network congestion. In many further embodiments, the WNC 408 may transmit the one or more roaming candidate sub-lists to the AP 402A, currently serving the first set of mobile devices 412A, and the AP 402A may transmit the corresponding sub-list to each of the first set of mobile devices 412A.

In yet more embodiments, the WNC 408 may be configured to predict traffic load for each of the plurality of roaming candidate APs 402B, 402C, and 402D. For example, the WNC 408 may predict traffic load for a roaming candidate AP based on transmitted sub-lists that include the roaming candidate AP as a potential roaming option. For example, the first sub-list includes the AP 402B as a potential roaming option and is sent to one mobile device 404A, the traffic load for the AP 402B can be predicted based on historical traffic analysis of the mobile device 404A. The WNC 408 may be further configured to transmit a traffic alert notification to each of the plurality of roaming candidate APs 402B, 402C, and 402D based on the predicted traffic load. The traffic alert notification to a roaming candidate AP may include information indicating at least one of the predicted traffic load or a type of mobile device expected to connect to the roaming candidate AP. For example, the traffic alert notification transmitted to the AP 402B may include information indicating at least one of the predicted traffic load or the type of the mobile device 404A expected to connect to the AP 402B. Such information may allow the plurality of roaming candidate APs 402B, 402C, and 402D to prepare for an upcoming roaming event and impending traffic.

In still further embodiments, the plurality of roaming candidate APs 402B, 402C, and 402D can skip off-channel scan cycles to effectively cater to the upcoming roaming event based on the traffic alert notifications. In other words, the plurality of roaming candidate APs 402B, 402C, and 402D, based on the traffic alert notifications, may temporarily suspend background scanning activities to maintain a strong and uninterrupted connection for the first set of mobile devices 412A. This approach may enhance network performance by evenly distributing the load and managing client diversity, ensuring a seamless experience for roaming mobile devices without overloading any single AP. In numerous embodiments, the WNC 408 may be configured to transmit the traffic alert notifications via a wired communication medium.

Although a specific embodiment for illustrating a network architecture suitable for carrying out the various steps, processes, methods, and operations described herein is discussed with respect to FIG. 4, any of a variety of systems and/or processes may be utilized in accordance with embodiments of the disclosure. For example, in numerous additional embodiments, the above-described operations can also be performed by an AP, a standalone device enabled with the assisted roaming logic, or the like. The elements depicted in FIG. 4 may also be interchangeable with other elements of FIGS. 1-3 and 5-10 as required to realize a particularly desired embodiment.

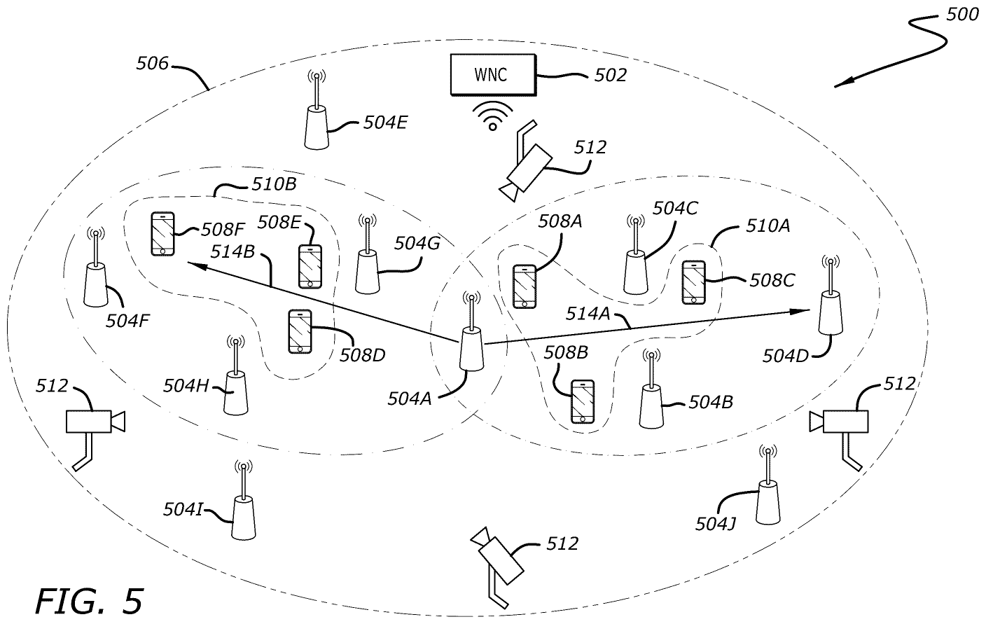

Referring to FIG. 5, a conceptual diagram of an example wireless network 500 in accordance with various embodiments of the disclosure is shown. The embodiments shown in FIG. 5 may illustrate a scenario where a WNC 502 manages a plurality of APs 504A, 504B, . . . 504J deployed in an area 506. The plurality of APs 504A-504J may be deployed in the area to provide connectivity to multiple mobile devices 508A, 508B, . . . , 508F. The wireless network 500 can be set up in various environments. For example, the wireless network 500 can be confined within a building, with the plurality of APs 504A-504J located indoors. In another example, the wireless network 500 can also extend to outdoor areas with some APs placed outside the building. In yet other examples, the wireless network 500 can be established in open spaces, covering outdoor areas entirely. In such examples, the plurality of APs 504A-504J may be located outdoors

The plurality of APs 504A-504J may be network devices (e.g., network nodes), each including a processor and a network interface controller configured to provide access to a network (for example, a wireless network). Each of the plurality of APs 504A-504J may further include a memory that may be coupled with the processor and may store an assisted roaming logic that may be executable by the processor. The plurality of APs 504A-504J may execute the assisted roaming logic to perform one or more operations for motion-aware and load-balanced assisted roaming. The plurality of APs 504A-504J may be configured to provide wireless connectivity to the mobile devices 508A-508F.

The mobile devices 508A-508F may correspond to electronic devices that roam within the area 506, connecting to the plurality of APs 504A-504J to access network services. The mobile devices 508A-508F may be equipped with wireless networking capabilities that allow the mobile devices 508A-508F to detect and connect to the plurality of APs 504A-504J as the mobile devices 508A-508F roam within the area 506. Examples of the mobile devices 508A-508F may include, but are not limited to, smartphones, laptops, tablets, phablets, E-readers, portable gaming consoles, digital cameras, portable media players, portable smart home devices, AR devices, IoT devices, wearables, or the like. As shown in FIG. 5, initially the mobile devices 508A-508F may be communicatively coupled to the AP 504A.

The WNC 502 may correspond to a centralized network device configured to oversee and coordinate the plurality of APs 504A-504J deployed within the area 506. The WNC 502 may be configured to manage, configure, and monitor the plurality of APs 504A-504J. In yet various embodiments, the WNC 502 may include a processor and a network interface controller configured to provide access to a network (for example, a wireless network). The network interface controller may be communicatively coupled to the plurality of APs 504A-504J. The WNC 502 may further include a memory that may be coupled with the processor and may store an assisted roaming logic. The assisted roaming logic may be executable by the processor. The WNC 502 may execute the assisted roaming logic to perform one or more operations for motion-aware and load-balanced assisted roaming.

In many embodiments, one or more APs among the plurality of APs 504A-504J may be enabled with sensing capabilities (hereinafter, interchangeably referred to as sensing-enabled APs or sensing devices). These sensing devices may be strategically located in the area 506 to maximize sensing coverage and accuracy of data collection. Along with performing other wireless connectivity related operations, these sensing devices may be further configured to sense and track one or more motion attributes of the mobile devices 508A-508F in the area 506. The one or more motion attributes may include movement direction, movement speed, movement velocity, acceleration, position, orientation, movement activities, or the like.

In a variety of embodiments, the WNC 502 may be configured to group the sensing devices operating in the area 506 and assign a common identifier. For example, the WNC 502 may assign a common identifier to transceivers of the one or more sensing-enabled APs. The sensing devices that are assigned a common identifier may operate as a coordinated sensing system that intercommunicates and collaborates. In other words, based on the assignment of the common identifier, the sensing devices intercommunicate to share sensed information regarding the one or more motion attributes with each other. Based on the collaboration and information sharing, the one or more sensing-enabled APs may validate the sensed information, prior to transmitting it to the WNC 502.

In several embodiments, the WNC 502 may be configured to schedule Wi-Fi sensing sessions for these sensing devices. For example, the sensing devices may sense the one or more motion attributes of the mobile devices 508A-508F during the scheduled Wi-Fi sensing sessions. In an example scenario, the WNC 502 may schedule the Wi-Fi sensing sessions based on traffic load prediction. For example, the WNC 502 may analyze network traffic handled by the one or more sensing-enabled APs and predict future load based on historical trends, current usage patterns, and any ongoing network demands. Once the load is predicted, the WNC 502 may schedule the Wi-Fi sensing sessions by allocating specific time slots to the one or more sensing-enabled APs to perform network scans and measurements for Wi-Fi sensing. These Wi-Fi sensing sessions can be scheduled to avoid peak usage times.

In several embodiments, the one or more motion attributes sensed by the one or more sensing-enabled APs may not be accurate. In many aspects, a sensing resolution of the one or more sensing-enabled APs may not be enough to sense the mobile devices 508A-508F. In further aspects, there may be a surge in a count of mobile devices in the area 506 and the one or more sensing-enabled APs may not be enough to handle the surge. For example, at an airport, the count of mobile devices can significantly increase when a flight lands and can result in crowded roaming events. In many further aspects, the one or more sensing-enabled APs may be busy handling network traffic of connected mobile devices and may be unable to perform sensing operations without disrupting the connectivity. Thus, in all such embodiments, the WNC 502 may activate an assisted sensing mode. In response to the activation of the assisted sensing mode, one or more assisted sensing devices 512 deployed in the area 506 may start sensing the one or more motion attributes of the mobile devices 508A-508F independently or along with the one or more sensing-enabled APs. Examples of the assisted sensing devices 512 may include, but are not limited to, IoT devices such as image sensors, video sensors, audio sensors, AR sensors, Infrared sensors, motion detectors, or the like.

In yet further embodiments, the coordinated sensing system (e.g., a virtual sensing group) may be mapped to dedicated assisted sensing devices. Thus, if there are multiple coordinated sensing systems operating in an area covering different portions of the area, assisted sensing devices located in respective area portions can be mapped to the coordinated sensing systems. Thus, if assisted sensing is required for a particular coordinated sensing system, the WNC 502 may only activate those assisted sensing devices mapped to the specific coordinated sensing system.

In an example scenario, the WNC 502 may compare a sensing resolution of the one or more sensing-enabled APs with a sensing resolution threshold. Examples of the sensing resolution may include spatial resolution, temporal resolution, or the like. In response to the sensing resolution of the one or more sensing-enabled APs being less than the sensing resolution threshold, the WNC 502 may activate the assisted sensing mode. Activating the assisted sensing mode may include operating the sensing devices along with the assisted sensing devices 512.

In a number of embodiments, the WNC 502 may be configured to receive the one or more motion attributes of the mobile devices 508A-508F from the sensing devices and/or the assisted sensing devices 512 and network usage data from the plurality of APs 504A-504J. In numerous additional embodiments, the WNC 502 may be configured to augment the network usage data with data related to the one or more motion attributes and create motion-tracking data. Further, the WNC 502 may determine a similarity in the one or more motion attributes (e.g., movement pattern) of the mobile devices 508A-508F based on the motion-tracking data.

In more embodiments, the WNC 502 may be configured to group a set of mobile devices, among the mobile devices 508A-508F, based on the similarity in the one or more motion attributes. For example, if the similarity in the one or more motion attributes of two or more mobile devices is less than a similarity threshold, the WNC 502 may group the two or more mobile devices. However, if the similarity in the one or more motion attributes of two or more mobile devices is greater than the similarity threshold, the two or more mobile devices may be considered to have dissimilar movement patterns, and hence may not be considered as part of the same group.

As shown in FIG. 5, the WNC 502 may group a first set of mobile devices 510A (including the mobile devices 508A, 508B, and 508C) in a first group and a second set of mobile devices 510B (including the mobile devices 508D, 508E, and 508F) in a second group. For example, the first set of mobile devices 510A may be determined to move along a first direction (indicated by arrow 514A) at a similar speed. Likewise, the second set of mobile devices 510B may be determined to move along a second direction (indicated by arrow 514B) at a similar speed.

As the mobile devices 508A-508F continue to move, uplink and downlink signal strengths of the mobile devices 508A-508F to the AP 504A may weaken. Such a decrease in the uplink and downlink signal strength may indicate an upcoming roaming event for the mobile devices 508A-508F. In such a scenario, the WNC 502 may be configured to execute one or more operations to enable motion-aware and load-balanced assisted roaming for the mobile devices 508A-508F. For the sake of brevity, the operations performed by the WNC 502 for enabling motion-aware and load-balanced assisted roaming are described with respect to the first set of mobile devices 510A.

In additional embodiments, the WNC 502 may be configured to identify a roaming candidate list for the first set of mobile devices 510A based on the one or more motion attributes of the first set of mobile devices 510A. In an example, the roaming candidate list may refer to a list of a plurality of roaming candidate APs that the first set of mobile devices 510A can connect to as they continue moving along the first direction (e.g., roaming path). In other words, the roaming candidate list may include those APs that are located along the roaming path of the first set of mobile devices 510A.

As shown in FIG. 5, the WNC 502 may identify that the APs 504B, 504C, and 504D are located along the roaming path of the first set of mobile devices 510A (e.g., along the first direction). In such a scenario, the identified APs 504B, 504C, and 504D may constitute the roaming candidate list for the first set of mobile devices 510A. Hereinafter, the APs 504B, 504C, and 504D may be referred to as “plurality of roaming candidate APs 504B, 504C, and 504D”.

In further embodiments, the WNC 502 may be configured to segment the roaming candidate list for the first set of mobile devices 510A into one or more roaming candidate sub-lists. In many aspects, the roaming candidate list may be segmented into the one or more roaming candidate sub-lists based on load balancing and client mix criteria among the plurality of roaming candidate APs 504B, 504C, and 504D (for example, as described in the foregoing description of FIG. 4). In still more embodiments, each of the one or more roaming candidate sub-lists may have a unique selection of roaming candidate APs based on the client profile and mix.

In further additional embodiments, the WNC 502 may be configured to map and distribute the one or more roaming candidate sub-lists among the first set of mobile devices 510A. The WNC 502 may distribute each sub-list in a manner that ensures mobile devices with low and high data usage are mixed to balance the AP load.

In other words, the WNC 502 may transmit a specific roaming candidate sub-list to a mobile device, guiding the mobile device to connect to the most optimal AP from the roaming candidate sub-list. Since different mobile devices in the same group may receive different sub-lists, the likelihood of all the mobile devices in the same group requesting connection to the same potential roaming candidate AP at the same time is reduced, resulting in improved network performance and reduced network congestion.

Although a specific embodiment depicting a wireless network being operable in an assisted sensing mode suitable for carrying out the various steps, processes, methods, and operations described herein is discussed with respect to FIG. 5, any of a variety of systems and/or processes may be utilized in accordance with embodiments of the disclosure. For example, in numerous additional embodiments, the WNC 502 may activate the assisted sensing mode if a count of mobile devices in the area 506 is greater than a threshold count. The WNC 502 may determine the count of mobile devices in the area 506 served by the one or more sensing-enabled APs and then compare the determined count of mobile devices with the threshold count. The threshold count may correspond to the maximum number of mobile devices that can be tracked by the one or more sensing-enabled APs at any given point in time. In response to the count of mobile devices in the area 506 being greater than the threshold count, the WNC 502 may activate the assisted sensing mode. The elements depicted in FIG. 5 may also be interchangeable with other elements of FIGS. 1-4 and 6-10 as required to realize a particularly desired embodiment.

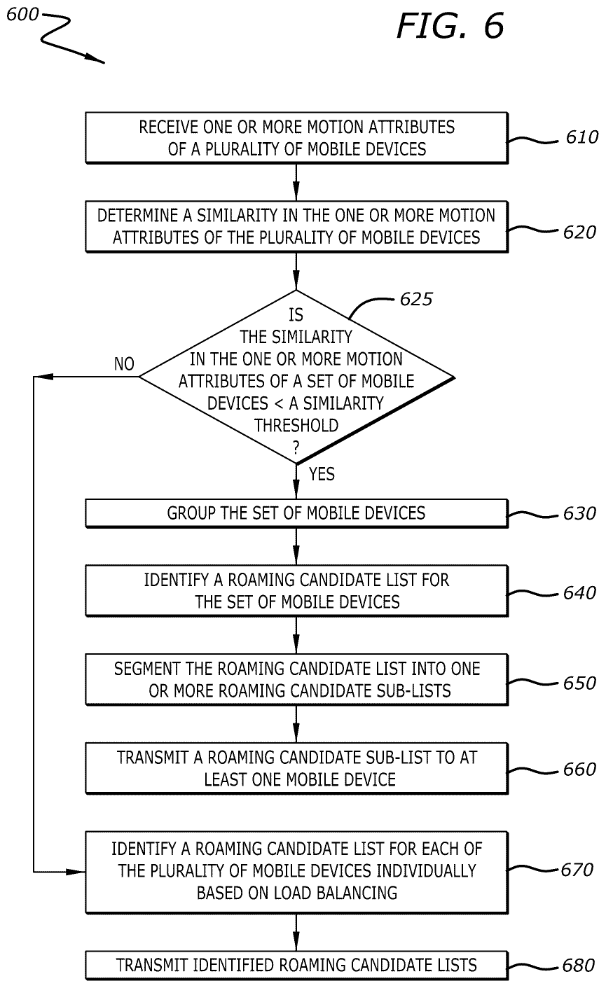

Referring to FIG. 6, a flowchart depicting a process 600 for motion-aware and load-balanced assisted roaming in accordance with various embodiments of the disclosure. In many embodiments, the process 600 may receive one or more motion attributes of a plurality of mobile devices (block 610). The plurality of mobile devices may be operated by users roaming in a particular area. In various embodiments, the one or more motion attributes of the plurality of mobile devices can be received from a plurality of sensing devices. The plurality of sensing devices may be strategically deployed in a particular area to sense the one or more motion attributes of the plurality of mobile devices. Examples of the plurality of sensing devices may include one or more sensing-enabled APs, one or more sensing-enabled WNCs, one or more sensing-enabled DNACs, or the like. In various additional embodiments, the one or more motion attributes of the mobile devices can be received from one or more assisted sensing devices independently or in collaboration with the plurality of sensing devices. Examples of the one or more assisted sensing devices may include various types of IoT sensors such as image sensors, edge-based cameras, video sensors, motion sensors, IR sensors, or the like. The one or more motion attributes may include attributes such as speed, direction, acceleration, location data, velocity, orientation, movement activities, or the like. The one or more motion attributes can be utilized to understand the movement patterns of the plurality of mobile devices.

In a number of embodiments, the process 600 may determine a similarity in the one or more motion attributes of the plurality of mobile devices (block 620). The similarity may be determined by comparing the one or more motion attributes of the plurality of mobile devices received within a particular time span, with each other. The one or more motion attributes of the plurality of mobile devices may be compared to identify one or more sets of mobile devices that exhibit similar movement patterns, indicating that they might be moving together or following similar paths. The similarity in the one or more motion attributes may be determined based on a similarity threshold. For example, the similarity in the one or more motion attributes can be determined based on a distance metric (such as Euclidean distance, Cosine Distance, or the like). The similarity threshold may define the maximum allowable distance metric for two mobile devices to be considered as having similar motion attributes. In other words, mobile devices for which the distance metric is less than or equal to the similarity threshold are considered to have similar motion attributes, indicating they are moving in close proximity and a similar direction.

In a variety of embodiments, the process 600 may determine whether the similarity in the one or more motion attributes of a set of mobile devices is less than the similarity threshold (block 625). In other words, the process 600 may check if the distance metric determined for the set of mobile devices is below the similarity threshold. Further, if the distance metric is less than the similarity threshold, it indicates a strong correlation in the one or more motion attributes.

In further embodiments, if the similarity is below the similarity threshold, the process 600 may group the set of mobile devices (block 630). In other words, the process 600 may group the set of mobile devices that satisfies the similarity threshold. For example, if the similarity in the one or more motion attributes of two or more mobile devices is less than the similarity threshold, the process 600 may group the two or more mobile devices.

In more embodiments, the process 600 may identify a roaming candidate list for the set of mobile devices (block 640). The roaming candidate list may be identified based on the one or more motion attributes of the set of mobile devices. For example, the roaming candidate list may include a plurality of roaming candidate APs that the set of mobile devices can connect to as they continue moving towards their destination. In other words, the roaming candidate list may include those APs that are located along a roaming path of the set of mobile devices and can provide the required signal strength for wireless communication. Since the set of mobile devices has similar motion attributes, the roaming path of the set of mobile devices is also similar. In an example, the roaming candidate list may correspond to a truncated version of traditional 802.11k.v list, in which potential roaming candidate APs are filtered based on the one or more motion attributes of the set of user devices.

In additional embodiments, the process 600 may segment the roaming candidate list into one or more roaming candidate sub-lists (block 650). Each of the one or more roaming candidate sub-lists has a unique selection of roaming candidate APs. In numerous additional embodiments, the process 600 may segment the roaming candidate list into the one or more roaming candidate sub-lists based on client profile mix, load balancing, or the like. For example, if 20 users are moving in one direction and there are three potential roaming candidate APs in the roaming candidate list. The process 600 may segment the roaming candidate list into multiple sub-lists, each sub-list including currently connected AP and two potential roaming candidate APs.

In still more embodiments, the process 600 may transmit a roaming candidate sub-list to at least one mobile device (block 660). In other words, once the roaming candidate sub-lists are obtained, each roaming candidate sub-list can be transmitted to one or more mobile devices within the group. In yet additional embodiments, each mobile device within the group may receive one roaming candidate sub-list.

In still further embodiments, if the similarity is greater than the similarity threshold, the process 600 may identify a roaming candidate list for each of the plurality of mobile devices individually based on load balancing (block 670). In other words, if no two or more devices satisfy the similarity threshold, each mobile device may be treated individually rather than as part of a group. Load balancing may involve distributing network traffic across multiple APs to ensure no single AP is overloaded.

In still additional embodiments, the process 600 may transmit the identified roaming candidate lists (block 680). In other words, each identified roaming candidate list is transmitted to corresponding mobile device among the plurality of mobile devices. The roaming candidate list may enable each mobile device to make informed roaming decisions.

Although a specific embodiment for motion-aware and load-balanced assisted roaming suitable for carrying out the various steps, processes, methods, and operations described herein is discussed with respect to FIG. 6, any of a variety of systems and/or processes may be utilized in accordance with embodiments of the disclosure. For example, the unique selection of roaming candidate APs may be based on one or more configuration parameters of the set of mobile devices. Examples of the one or more configuration parameters may include mode of operation, supported standards, supported frequency bands, or the like. The elements depicted in FIG. 6 may also be interchangeable with other elements of FIGS. 1-5 and 7-10 as required to realize a particularly desired embodiment.

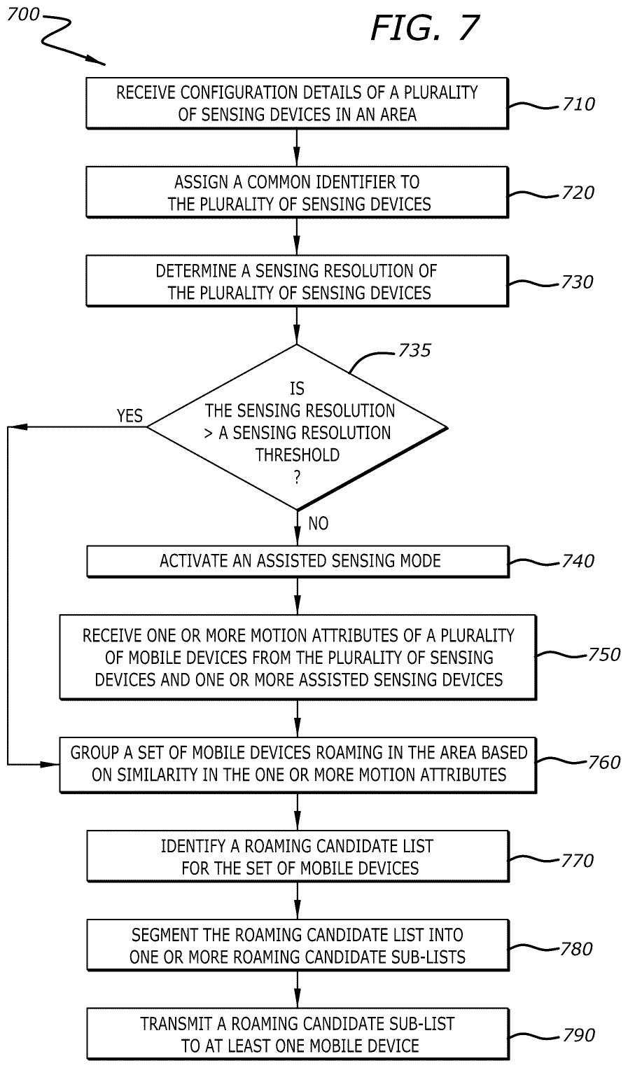

Referring to FIG. 7, a flowchart depicting a process 700 for motion-aware and load-balanced assisted roaming with assisted sensing mode in accordance with various embodiments of the disclosure. In many embodiments, the process 700 may receive configuration details of a plurality of sensing devices in an area (block 710). The plurality of sensing devices may be strategically deployed in a particular area to sense one or more motion attributes of mobile devices present in the area. Examples of the plurality of sensing devices may include one or more sensing-enabled APs, one or more sensing-enabled WNCs, one or more sensing-enabled DNACs, or the like. The configuration details may include the location of each sensing device, sensing scan cycle information, coverage area, data sampling rate, sensing resolution, or the like.

In a number of embodiments, the process 700 may assign a common identifier to the plurality of sensing devices (block 720). The plurality of sensing devices that are assigned the common identifier may operate as a coordinated sensing system that intercommunicates and collaborates. In other words, based on the assignment of the common identifier, the plurality of sensing devices intercommunicates to share sensed information with each other. Based on the collaboration and information sharing, the plurality of sensing devices may validate the sensed information, thus, enhancing the accuracy of the sensed information.

In a variety of embodiments, the process 700 may determine a sensing resolution of the plurality of sensing devices (block 730). In various embodiments, the sensing resolution may refer to the granularity and accuracy of data sensed by a sensing device. The determination of sensing resolution may involve assessing factors such as spatial resolution, temporal resolution, and precision of measurements of the sensing device. In numerous embodiments, the process 700 may compare the sensing resolution with a sensing resolution threshold. The sensing resolution threshold may represent the minimum acceptable resolution for effective sensing and monitoring.

In more embodiments, the process 700 may determine whether the sensing resolution is greater than the sensing resolution threshold (block 735). In yet more embodiments, in response to the sensing resolution being less than the sensing resolution threshold, the process 700 may activate an assisted sensing mode (block 740). The activation of the assisted sensing mode may include operating one or more assisted sensing devices along with the plurality of sensing devices to enhance sensing capabilities. Assisted sensing may involve utilizing one or more motion sensors, integrating data from other sources such as a closed-circuit television (CCTV), edge-based cameras, an infrared sensor, or using mobile devices present in the area to supplement the sensing devices.

In further embodiments, the process 700 may receive one or more motion attributes of a plurality of mobile devices from the plurality of sensing devices and the one or more assisted sensing devices (block 750). These motion attributes may indicate motion-tracking data such as speed, direction, velocity, acceleration, orientation, movement activities, and location of each mobile device within the area. In many further embodiments, network usage data tracked by the plurality of sensing devices can be augmented with data related to the one or more motion attributes, thus creating enhanced motion-tracking data. Such motion tracking may ensure that each of the mobile devices in the area is tracked by the plurality of sensing devices and the one or more assisted sensing devices.

In still more embodiments, the process 700 may group a set of mobile devices roaming in the area based on similarity in the one or more motion attributes (block 760). In other words, using the received motion attributes, the process 700 may determine a similarity in the movement pattern of two or more mobile devices and group the mobile devices exhibiting similar movement patterns. For example, if the similarity in the one or more motion attributes of two or more mobile devices is less than the similarity threshold, the process 700 may group the two or more mobile devices. In various embodiments, the process 700 may utilize one or more clustering techniques, such as K-nearest neighbor scan, Density-Based Spatial Clustering techniques, or the like.

After grouping the set of devices, in still further embodiments, the process 700 may identify a roaming candidate list for the set of mobile devices (block 770). The roaming candidate list may be identified based on the one or more motion attributes of the set of mobile devices. For example, the roaming candidate list may include a plurality of roaming candidate APs that the set of mobile devices can connect to as they continue moving towards their destination. In other words, the roaming candidate list may include those APs that are located along a roaming path of the set of mobile devices and can provide the required signal strength for wireless communication. For example, at a large airport, mobile devices moving towards exit doors may be grouped and a list of potential roaming candidate APs can be identified for roaming connectivity.

In still additional embodiments, the process 700 may segment the roaming candidate list into one or more roaming candidate sub-lists (block 780). In other words, the compiled list of roaming candidates may be split into smaller, more specific sub-lists. In numerous additional embodiments, the process 700 may segment the roaming candidate list into the one or more roaming candidate sub-lists based on client profile mix, load balancing, or the like.

In some more embodiments, the process 700 may transmit a roaming candidate sub-list to at least one mobile device (block 790). In other words, once the roaming candidate sub-lists are obtained, each roaming candidate sub-list can be transmitted to one or more mobile devices within the group. In yet additional embodiments, each mobile device within the group may receive one roaming candidate sub-list. In further additional embodiments, in response to the sensing resolution of the plurality of sensing devices being greater than the sensing resolution threshold, the process 700 may not activate the assisted sensing mode and group the set of mobile devices based on similarity in the one or more motion attributes received solely from the plurality of sensing devices (block 760).

Although a specific embodiment for motion-aware and load-balanced assisted roaming with assisted sensing mode suitable for carrying out the various steps, processes, methods, and operations described herein is discussed with respect to FIG. 7, any of a variety of systems and/or processes may be utilized in accordance with embodiments of the disclosure. For example, the process 700 may activate the assisted sensing mode based on a count of mobile devices present in the area. The elements depicted in FIG. 7 may also be interchangeable with other elements of FIGS. 1-6 and 8-10 as required to realize a particularly desired embodiment.

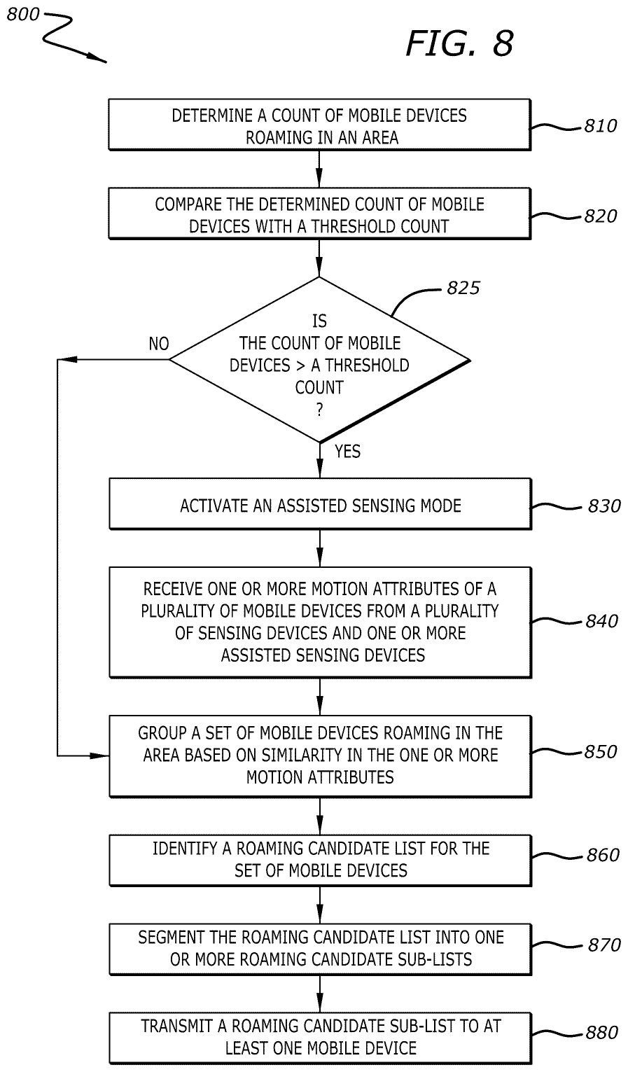

Referring to FIG. 8, a flowchart showing a process 800 for motion-aware and load-balanced assisted roaming with assisted sensing mode in accordance with various embodiments of the disclosure is shown. In many embodiments, the process 800 may determine a count of mobile devices roaming in an area (block 810). The process 800 may determine the count of mobile devices currently present and moving within the area. For example, when a mobile device enters the range of an AP, the mobile device may send out a probe request to identify available networks. APs in the area can capture these probe requests, which contain unique identifiers. By logging interactions of the APs in the area with mobile devices, the process 800 can obtain data on a number of unique mobile devices in the area and can then determine the count of mobile devices within the area.

In a number of embodiments, the process 800 may compare the determined count of mobile devices with a threshold count (block 820). The threshold count may define the maximum limit of the count of mobile devices that can be effectively sensed by a plurality of sensing devices in the area without requiring any assistance from assisting sensing devices. For example, if the threshold count is set to 250 devices and the count is 360, the process 800 may identify that the count of mobile devices exceeds the threshold count. Such comparison can help determine if assisted sensing devices are needed.

In a variety of embodiments, the process 800 may determine whether the count of mobile devices is greater than the threshold count (block 825). In other words, the process 800 may check if the number of mobile devices surpasses the threshold count. In response to the count of mobile devices exceeding the threshold count, in further additional embodiments, the process 800 may activate an assisted sensing mode (block 830). The activation of the assisted sensing mode may include operating one or more assisted sensing devices along with the plurality of sensing devices to enhance sensing capabilities. Assisted sensing may involve utilizing one or more motion sensors, integrating data from other sources such as a CCTV, edge-based cameras, an infrared sensor, or using mobile devices present in the area to supplement the sensing devices.

In further embodiments, the process 800 may receive one or more motion attributes of a plurality of mobile devices from the plurality of sensing devices and one or more assisted sensing devices (block 840). These motion attributes may indicate motion-tracking data such as speed, direction, velocity, acceleration, orientation, movement activities, and location of each mobile device within the area. In many further embodiments, network usage data tracked by the plurality of sensing devices can be augmented with data related to the one or more motion attributes, thus creating enhanced motion-tracking data. Such motion tracking may ensure that each of the mobile devices in the area is tracked by the plurality of sensing devices and the one or more assisted sensing devices.

In still more embodiments, the process 800 may group a set of mobile devices roaming in the area based on similarity in the one or more motion attributes (block 850). In other words, using the received motion attributes, the process 800 may determine a similarity in the movement pattern of two or more mobile devices and group the mobile devices exhibiting similar movement patterns. For example, if the similarity in the one or more motion attributes of two or more mobile devices is less than the similarity threshold, the process 800 may group the two or more mobile devices. In various embodiments, the process 800 may utilize one or more clustering techniques, such as K-nearest neighbor scan, Density-Based Spatial Clustering techniques, or the like.

After grouping the set of mobile devices, in still further embodiments, the process 800 may identify a roaming candidate list for the set of mobile devices (block 860). The roaming candidate list may be identified based on the one or more motion attributes of the set of mobile devices. For example, the roaming candidate list may include a plurality of roaming candidate APs that the set of mobile devices can connect to as they continue moving towards their destination. In other words, the roaming candidate list may include those APs that are located along a roaming path of the set of mobile devices and can provide the required signal strength for wireless communication.

In still additional embodiments, the process 800 may segment the roaming candidate list into one or more roaming candidate sub-lists (block 870). In other words, the compiled list of roaming candidates may be split into smaller, more specific sub-lists. In numerous additional embodiments, the process 800 may segment the roaming candidate list into the one or more roaming candidate sub-lists based on client profile mix, load balancing, or the like.

In some more embodiments, the process 800 may transmit a roaming candidate sub-list to at least one mobile device (block 880). In other words, once the roaming candidate sub-lists are obtained, each roaming candidate sub-list can be transmitted to one or more mobile devices within the group. In yet additional embodiments, each mobile device within the group may receive one roaming candidate sub-list. In further additional embodiments, in response to the count of mobile devices being less than the threshold count, the process 800 may not activate the assisted sensing mode and group the set of mobile devices based on similarity in the one or more motion attributes received solely from the plurality of sensing devices (block 850).

Although a specific embodiment for activating an assisted sensing mode suitable for carrying out the various steps, processes, methods, and operations described herein are discussed with respect to FIG. 8, any of a variety of systems and/or processes may be utilized in accordance with embodiments of the disclosure. For example, the process 800 may activate the assisted sensing mode based on a sensing resolution of the plurality of sensing devices. The elements depicted in FIG. 8 may also be interchangeable with other elements of FIGS. 1-7 and 9-10 as required to realize a particularly desired embodiment.

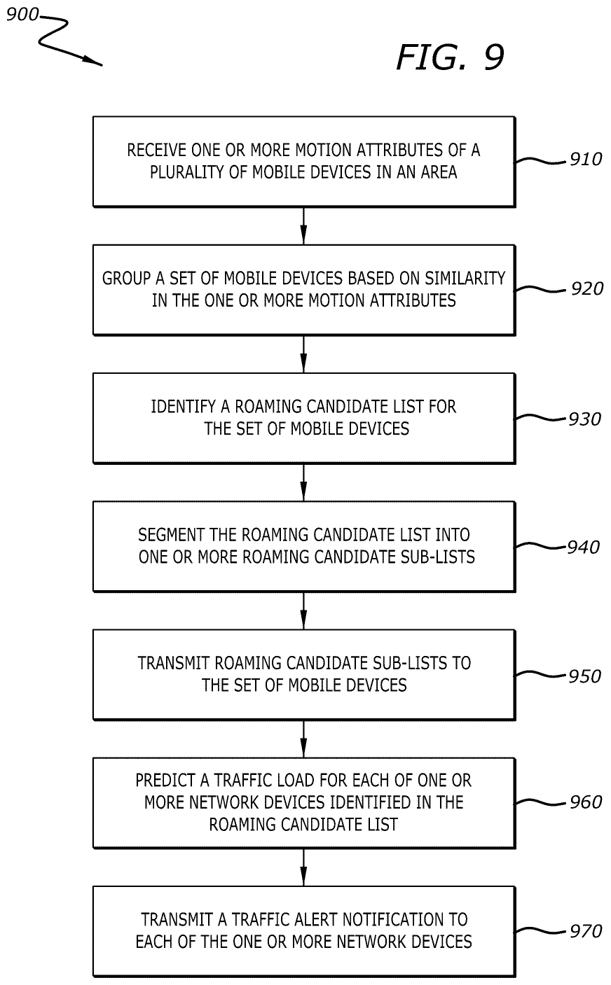

Referring to FIG. 9, a flowchart showing a process 900 for alerting potential roaming candidate APs regarding a crowded roaming event in accordance with various embodiments of the disclosure is shown. In many embodiments, the process 900 may receive one or more motion attributes of a plurality of mobile devices in an area (block 910). The plurality of mobile devices may be operated by users roaming in a particular area. In various embodiments, the one or more motion attributes of the plurality of mobile devices can be received from a plurality of sensing devices. The plurality of sensing devices may be strategically deployed in a particular area to sense the one or more motion attributes of the plurality of mobile devices. Examples of the plurality of sensing devices may include one or more sensing-enabled APs, one or more sensing-enabled WNCs, one or more sensing-enabled DNACs, or the like. In various additional embodiments, the one or more motion attributes of the mobile devices can be received from one or more assisted sensing devices independently or in collaboration with the plurality of sensing devices. Examples of the one or more assisted sensing devices may include various types of IoT sensors such as image sensors, edge-based cameras, video sensors, motion sensors, IR sensors, or the like. The one or more motion attributes may include attributes such as speed, direction, acceleration, location data, velocity, orientation, movement activities, or the like. The one or more motion attributes can be utilized to understand the movement patterns of the plurality of mobile devices.

In a variety of embodiments, the process 900 may group a set of mobile devices based on similarity in the one or more motion attributes (block 920). The similarity may be determined by comparing the one or more motion attributes of the plurality of mobile devices received within a particular time span, with each other. The one or more motion attributes of the plurality of mobile devices may be compared to identify one or more sets of mobile devices that exhibit similar movement patterns, indicating that they might be moving together or following similar paths. The similarity in the one or more motion attributes may be determined based on a similarity threshold. For example, the similarity in the one or more motion attributes can be determined based on a distance metric (such as Euclidean distance, Cosine Distance, or the like). The similarity threshold may define the maximum allowable distance metric for two mobile devices to be considered as having similar motion attributes. In other words, mobile devices for which the distance metric is less than or equal to the similarity threshold are considered to have similar motion attributes, and thus can be grouped.

In numerous additional embodiments, the process 900 may identify a roaming candidate list for the set of mobile devices (block 930). The roaming candidate list may be identified based on the one or more motion attributes of the set of mobile devices. For example, the roaming candidate list may include a plurality of roaming candidate APs that the set of mobile devices can connect to as they continue moving towards their destination. In other words, the roaming candidate list may include those APs that are located along a roaming path of the set of mobile devices and can provide the required signal strength for wireless communication. In an example, the roaming candidate list may correspond to a truncated version of traditional 802.11k.v list, in which potential roaming candidate APs are filtered based on the one or more motion attributes of the set of user devices.

In still more embodiments, the process 900 may segment the roaming candidate list into one or more roaming candidate sub-lists (block 940). Each of the one or more roaming candidate sub-lists has a unique selection of roaming candidate APs. In numerous additional embodiments, the process 900 may segment the roaming candidate list into the one or more roaming candidate sub-lists based on client profile mix, load balancing, or the like. For example, if 20 users are moving in one direction and there are three potential roaming candidate APs in the roaming candidate list. The process 900 may segment the roaming candidate list into multiple sub-lists, each sub-list including currently connected AP and two potential roaming candidate APs.

In several embodiments, the process 900 may transmit roaming candidate sub-lists to the set of mobile devices (block 950). In other words, once the roaming candidate sub-lists are obtained, each roaming candidate sub-list can be transmitted to one or more mobile devices within the group. In yet additional embodiments, each mobile device within the group may receive one roaming candidate sub-list and one roaming candidate sub-list can be transmitted to one or more mobile devices in the same group.

In further embodiments, the process 900 may predict a traffic load for each of one or more network devices identified in the roaming candidate list (block 960). In other words, the traffic load may be forecasted for each network device, such as APs, identified in the roaming candidate list. For example, the process 900 may predict traffic load for a roaming candidate network device based on transmitted sub-lists that include the roaming candidate network device as a potential roaming option. For example, if a sub-list includes “AP1” as a potential roaming option and is sent to two mobile devices, the traffic load for “AP1” can be predicted based on historical traffic analysis of the two mobile devices. In other words, the process 900 may predict a traffic load for each of the one or more network devices for an upcoming roaming event.

In a number of embodiments, the process 900 may transmit a traffic alert notification to each of the one or more network devices (block 970). The traffic alert notification to a roaming candidate network device may include information indicating at least one of the predicted traffic load or a type of mobile device expected to connect to the roaming candidate network device. For example, the traffic alert notification transmitted to “AP1” may include information indicating at least one of the predicted traffic load or the type of the mobile devices expected to connect to “AP1”. Such information may allow the one or more network devices to prepare for an upcoming roaming event and impending traffic. In still further embodiments, the one or more network devices can skip off-channel scan cycles to effectively cater to the upcoming roaming event based on the traffic alert notifications. In other words, the one or more network devices, based on the traffic alert notifications, may temporarily suspend background scanning activities to maintain a strong and uninterrupted connection for the set of mobile devices. Such alert notifications may allow network administrators to take preemptive actions, such as reallocating resources or adjusting network settings to handle the expected load. In numerous embodiments, the process 900 may transmit the traffic alert notifications via a wired communication medium.

Although a specific embodiment for alerting potential roaming candidate APs regarding a crowded roaming event suitable for carrying out the various steps, processes, methods, and operations described herein is discussed with respect to FIG. 9, any of a variety of systems and/or processes may be utilized in accordance with embodiments of the disclosure. For example, prediction of traffic load may be performed by a WNC. The elements depicted in FIG. 9 may also be interchangeable with other elements of FIGS. 1-8 and FIG. 10 as required to realize a particularly desired embodiment.

Referring to FIG. 10, a conceptual block diagram of a device 1000 suitable for configuration with an assisted roaming logic, in accordance with various embodiments of the disclosure is shown. The embodiment of the conceptual block diagram depicted in FIG. 10 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many non-limiting examples, correspond to physical devices or virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020 and applications 1022. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of the physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In certain embodiments, the device 1000 can also include computer-readable storage media having instructions stored thereupon for performing any of the other computer-implemented operations described herein.

In many further embodiments, the device 1000 may include an assisted roaming logic 1024. The assisted roaming logic 1024 can be configured to perform one or more of the various steps, processes, operations, and/or other methods that are described above. Often, the assisted roaming logic 1024 can be a set of instructions stored within a non-volatile memory that, when executed by the processor(s)/controller(s) 1004 can carry out these steps, etc. In some embodiments, the assisted roaming logic 1024 may be a client application that resides on a network-connected device, such as, but not limited to, a server, switch, personal or mobile computing device in a single or distributed arrangement.

In certain embodiments, the assisted roaming logic 1024 may group a set of mobile devices roaming in an area based on similarity in one or more motion attributes. The assisted roaming logic 1024 may receive the one or more motion attributes of the set of mobile devices from a plurality of sensing devices and/or one or more assisted sensing devices in the area. The assisted roaming logic 1024 may further determine whether the similarity in the one or more motion attributes of the set of mobile devices is greater than a similarity threshold in order to group the set of mobile devices. The assisted roaming logic 1024 may then identify a roaming candidate list for the set of mobile devices based on the one or more motion attributes. The roaming candidate list may include a plurality of roaming candidate APs for the set of mobile devices. The assisted roaming logic 1024 may further predict a traffic load for each of the plurality of roaming candidate APs based on a count of the set of mobile devices grouped and load balance the predicted traffic load among the plurality of roaming candidate APs. The assisted roaming logic 1024 may further segment the roaming candidate list into one or more roaming candidate sub-lists. Each of the one or more roaming candidate sub-lists has a unique selection of roaming candidate APs based on one or more configuration parameters of the set of mobile devices.

The assisted roaming logic 1024 may transmit a roaming candidate sub-list of the one or more roaming candidate sub-lists to at least one mobile device of the set of mobile devices. The assisted roaming logic 1024 may further transmit a traffic alert notification to each of the roaming candidate APs based on the predicted traffic load. In other words, the AP may send a traffic alert notification that may include information indicating at least one of the predicted traffic load or a type of mobile device expected to connect to the roaming candidate AP.

The assisted roaming logic 1024 may be configured with an assisted sensing mode that may be activated when the sensing devices are unable to provide accurate information about the motion attributes of the plurality of mobile devices in the area. Activating the assisted sensing mode may include operating the sensing devices along with one or more assisted sensing devices.

In some embodiments, the configuration data 1028 may comprise configuration parameters of the plurality of roaming candidate APs. The configuration parameters may include SSIDs (for network identification), channel and channel width (for frequency management, and transmit power to control signal strength), security settings (Wi-Fi Protected Access 3 (WPA3) and MAC, VLAN configuration, Quality of Service (QOS) (for prioritizing traffic), Dynamic Host Configuration Protocol (DHCP) settings, firmware updates, guest network configurations, mesh network integration, and supporting roaming parameters such as 802.11r, 802.11k, and 802.11v, beacon intervals, IP Version 6 (IPv6) support, and location services. The configuration data 1028 may further include one or more configuration parameters of the set of mobile devices that may encompass a wide range of settings managing network connectivity, security, and personalization and may vary from one type of mobile device to another type of mobile device. In further embodiments, the configuration data 1028 may be utilized by the assisted roaming logic 1024 to segment the roaming candidate list into the one or more roaming candidate sub-lists.

In various embodiments, the motion attribute data 1030 can comprise various attributes that describe the movement characteristics of a mobile device. Examples of the motion attributes can include direction (e.g., north, south), speed (measured in meters per second or kilometers per hour), and/or velocity (speed with a specified direction). The motion attribute data 1030 may also encompass acceleration (rate of change of speed), location trajectory, orientation (physical tilt or angle of the device), and movement activities (behavior over time, such as regular stops or changes in direction, running, walking, etc.). Analyzing the motion attribute data 1030 may enable the assisted roaming logic 1024 to manage roaming events, especially in dense and crowded networks, more effectively.

In a number of embodiments, the traffic load data 1032 may comprise information on the volume and characteristics of data transmitted through a network, essential for managing and optimizing performance. Key components include of the traffic load data 1032 may include data usage, data volume (total data transmitted), bandwidth utilization (percentage of capacity used), number of connected devices, throughput (data transmission rate), latency (time delay in transmission), packet loss (percentage of lost data packets), connection duration, peak usage times, application-specific traffic (e.g., streaming, browsing), and QoS metrics (e.g., jitter, error rates). In further embodiments, the traffic load data 1032 and the motion attribute data 1030 may be stored, for example temporarily, in an encrypted format, to ensure that sensitive data is not exposed and user privacy is maintained.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform the functions described herein. The virtualization layer may generally support a virtual resource that performs at least a portion of the techniques described herein.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model 1026 may be configured to learn a traffic load pattern at various times of the day for a roaming candidate AP based on data related to traffic load data for a plurality of roaming candidate APs, and predict the traffic load for the particular roaming candidate AP. Such predictions may be utilized to preemptively alert the roaming candidate AP regarding a roaming event and impending traffic.

The ML model(s) 1026 can be configured to generate inferences to make predictions or draw conclusions from data. An inference can be considered the output of a process of applying a model to new data. This can occur by learning from at least the configuration data 1028, the motion attribute data 1030, and the traffic load data 1032. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for a device suitable for configuration with the assisted roaming logic for carrying out the various steps, processes, methods, and operations described herein is discussed with respect to FIG. 10, any of a variety of systems and/or processes may be utilized in accordance with embodiments of the disclosure. For example, the device 1000 may be in a virtual environment such as a cloud-based network administration suite, or it may be distributed across a variety of network devices or APs. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises an assisted roaming logic that is configured to:
group, based on similarity in one or more motion attributes, a set of mobile devices roaming in an area;
identify a roaming candidate list for the set of mobile devices based on the one or more motion attributes;
segment the roaming candidate list into one or more roaming candidate sub-lists; and
transmit a roaming candidate sub-list of the one or more roaming candidate sub-lists to at least one mobile device of the set of mobile devices.

2. The device of claim 1, wherein each of the one or more roaming candidate sub-lists has a unique selection of roaming candidate access points (APs).

3. The device of claim 2, wherein the unique selection of roaming candidate APs is based on one or more configuration parameters of the set of mobile devices.

4. The device of claim 1, wherein the roaming candidate list comprises a plurality of roaming candidate APs for the set of mobile devices.

5. The device of claim 4, wherein the roaming candidate list is segmented into the one or more roaming candidate sub-lists based on load balancing among the plurality of roaming candidate APs.

6. The device of claim 1, wherein the assisted roaming logic is further configured to:
receive the one or more motion attributes of the set of mobile devices from a plurality of sensing devices in the area; and
determine that the similarity in the one or more motion attributes of the set of mobile devices is less than a similarity threshold, wherein the set of mobile devices is grouped based on the determination that the similarity in the one or more motion attributes of the set of mobile devices is less than the similarity threshold.

7. The device of claim 6, wherein the one or more motion attributes comprise at least one of a movement direction, a movement speed, or a movement velocity.

8. The device of claim 6, wherein the assisted roaming logic is further configured to assign a common identifier to the plurality of sensing devices.

9. The device of claim 8, wherein the plurality of sensing devices assigned with the common identifier operates as a coordinated sensing system that intercommunicates.

10. The device of claim 6, wherein the assisted roaming logic is further configured to activate an assisted sensing mode of the device.

11. The device of claim 10, wherein activating the assisted sensing mode comprises operating the plurality of sensing devices along with one or more assisted sensing devices.

12. The device of claim 11, wherein the one or more assisted sensing devices includes at least one Internet of Things (IoT) sensor.

13. The device of claim 10, wherein the assisted roaming logic is further configured to:
compare a sensing resolution of the plurality of sensing devices with a sensing resolution threshold; and
activate the assisted sensing mode in response to the sensing resolution of the plurality of sensing devices being less than the sensing resolution threshold.

14. The device of claim 10, wherein the assisted roaming logic is further configured to:
determine a count of mobile devices in the area served by the plurality of sensing devices;
compare the determined count of mobile devices with a threshold count; and
activate the assisted sensing mode based on the count of mobile devices in the area being greater than the threshold count.

15. The device of claim 6, wherein the plurality of sensing devices comprises one or more sensing-enabled APs, one or more sensing-enabled wireless network controllers, or one or more sensing-enabled dynamic network access controllers.

16. The device of claim 1, wherein the device is one of a wireless network controller, a dynamic network access controller, or an AP.

17. A device, comprising:
a processor;
a network interface controller communicatively coupled to a plurality of network devices deployed in an area; and
a memory communicatively coupled to the processor, wherein the memory comprises an assisted roaming logic that is configured to:
group, based on similarity in one or more motion attributes, a set of mobile devices roaming in the area;
identify a roaming candidate list for the set of mobile devices, wherein the roaming candidate list includes one or more network devices of the plurality of network devices;
predict a traffic load for each of the one or more network devices; and
transmit a traffic alert notification to each of the one or more network devices based on the predicted traffic load.

18. The device of claim 17, wherein the roaming candidate list is identified based on the one or more motion attributes of the set of mobile devices.

19. The device of claim 17, wherein the traffic alert notification transmitted to a network device of the one or more network devices is configured to indicate at least one of the traffic load or a type of mobile device expected to connect to the network device.

20. An assisted roaming method, comprising:
grouping, based on similarity in one or more motion attributes, a set of mobile devices roaming in an area;
identifying a roaming candidate list for the set of mobile devices based on the one or more motion attributes;
segmenting the roaming candidate list into one or more roaming candidate sub-lists; and
transmitting a roaming candidate sub-list of the one or more roaming candidate sub-lists to at least one mobile device of the set of mobile devices.
